(19) United States
(12) Patent Application Publication
(10) Pub. No.: US 2026/0219779 A1
(43) Pub. Date: Jul. 30, 2026

(54) Methods and Systems for Adjusting a Range Feature of an Editor Tool to Automatically Adjust a Range of Data Values in a Range Region and Automatically Adjust a Corresponding Field View of a Data Display

(71) Applicant: Precision Planting LLC, Tremont, IL (US)

(72) Inventors: Matthew Nelson, Peoria, IL (US); David Aaron Wilcoxson, Tremont, IL (US); Emil Bandy, Pekin, IL (US)

(21) Appl. No.: 19/145,953

(22) PCT Filed: Dec. 21, 2023
(86) PCT No.: PCT/IB2023/063091

§ 371 Date: Jul. 7, 2025

Related U.S. Application Data
(60) Provisional application No. 63/479,590, filed on Jan. 12, 2023.

(51) Int. Cl. G06F 3/04847; B60K 35/10; B60K 35/22

(52) U.S. Cl. CPC G06F 3/04847; B60K 35/10; B60K 35/22; B60K 2360/11

(57) ABSTRACT

Systems and methods for adjusting a range feature, a range region, and corresponding field views of agricultural fields. In one embodiment, a computer implemented method includes displaying a user interface (UI) on the display device with the UI displaying a range region having color steps to illustrate a first range of data values for a parameter, an editor tool, and a field view region to display the first range of data values for the parameter in an agricultural field. The method includes receiving, with a range feature of the editor tool, a user input to adjust the range feature to adjust the first range of data values of the parameter and automatically generating an adjusted range region having an adjusted second range of data values of the parameter and also automatically generating a corresponding adjusted field region having the adjusted second range of data values.

### CROSS REFERENCE TO RELATED APPLICATIONS

This application claims priority to U.S. Provisional Application No. 63/479,590, filed 12 Jan. 2023, which is incorporated herein by reference in its entirety.

### TECHNICAL FIELD

Embodiments of the present disclosure relate to methods and systems for adjusting a range feature of an editor tool to automatically adjust a range of data values in a range region and automatically adjust a corresponding field view of a data display.

### BACKGROUND

Planters are used for planting seeds of crops (e.g., corn, soybeans) in a field. Some planters include a display monitor within a cab for displaying a coverage map that shows regions of the field that have been planted. The coverage map of the planter is generated based on planting data collected by the planter.

A combine harvester or combine is a machine that harvests crops. A coverage map of a combine displays regions of the field that have been harvested by that combine. A coverage map allows the operator of the combine to know that a region of the field has already been harvested by the same combine. The coverage map may be difficult to understand for planting and harvesting parameters.

### BRIEF SUMMARY

In an aspect of the disclosure there is provided a computer implemented method for adjusting a range of data values on a display device comprising displaying a user interface (UI) on the display device with the UI displaying a range region having a first number of color steps to illustrate a first range of data values for a parameter, an editor tool, and a field view region to display the first range of data values for the parameter in an agricultural field. The method includes receiving, with a range feature of the editor tool, a user input to adjust a position, a first end for a lower limit, or a second end for an upper limit of the range feature to adjust the first range of data values of the parameter, and automatically generating an adjusted range region having an adjusted second range of data values of the parameter and also automatically generating a corresponding adjusted field region having the adjusted second range of data values based on the user input.

In one example of the computer implemented method, further comprising displaying, with the display device, the adjusted range region having an adjusted second range of data values of the parameter and the corresponding adjusted field region having the adjusted second range of data values based on the user input.

In one example of the computer implemented method, wherein the user input to adjust a position of the range feature to shift the first range of data values higher or lower.

In one example of the computer implemented method, wherein the user input to adjust a first end of the range feature to adjust a lower limit of the first range of data values to form a second range of data values.

In one example of the computer implemented method, wherein the user input to adjust a second end of the range feature to adjust an upper limit of the first range of data values of the parameter to form a third range of data values.

In one example of the computer implemented method, further comprising receiving, with the editor tool, a user input to edit the first number of color steps with each step having a range of data values displayed in the range region.

In one example of the computer implemented method, further comprising automatically changing the range region to have a second number of steps with each step having an adjusted range of data values based on the user input for the editor tool.

In one example of the computer implemented method, wherein the parameter comprises plant summary, closing, down force, insecticide, weed & feed, nitrogen, starter, fungicide, seeding, or population.

In another aspect of the present disclosure, there is provided a system comprising a display device for displaying a user interface having a range region with a first number of color steps to illustrate a first range of data values for a parameter, an editor tool, and a field view region to display the first range of data values for the parameter in an agricultural field and at least one processor coupled to the display device. The at least one processor is configured to execution instructions to generate data for the user interface (UI) of the display device, to receive from a range feature of the editor tool a user input to adjust a position, a first end for a lower limit, or a second end for an upper limit of the range feature to adjust the first range of data values of the parameter, and automatically generate an adjusted range region having an adjusted second range of data values of the parameter and also automatically generate a corresponding adjusted field region having the adjusted second range of data values based on the user input.

In one example of the system, wherein the display device is configured to display the adjusted range region having an adjusted second range of data values of the parameter and the corresponding adjusted field region having the adjusted second range of data values based on the user input.

In one example of the system, wherein the user input to adjust a position of the range feature to shift the first range of data values higher or lower.

In one example of the system, wherein the user input to adjust a first end of the range feature to adjust a lower limit of the first range of data values.

In one example of the system, wherein the user input to adjust a second end of the range feature to adjust an upper limit of the first range of data values of the parameter.

In one example of the system, further comprising receiving, with the editor tool, a user input to edit the first number of color steps with each step having a range of data values displayed in the range region.

In one example of the system, further comprising automatically changing the range region to have a second number of steps with each step having an adjusted range of data values based on the user input for the editor tool.

In one example of the system, wherein the parameter comprises plant summary, closing, down force, insecticide, weed & feed, nitrogen, starter, fungicide, seeding, or population.

In another aspect of the present disclosure a computer implemented method for adjusting range of a range region and corresponding field views of a field region of data displays comprising displaying a user interface (UI) on a display device with the UI displaying a range region having a number of color steps to illustrate a first range of data values for a parameter, an editor tool, and a field view region to display the first range of data values for the parameter in an agricultural field, receiving, with a range feature of the editor tool, a user input to enable a highlight mode, and automatically adjusting the range region to have a single color step for the first range of data values, adjusting the range feature to have the same color as the single color step, and adjusting the field view to display the first range of data values with the same color as the single color step based on the user input for the highlight mode.

In one example of the computer implemented method, further comprising receiving, with the range feature, a user input to move a first end of the range feature to increase or decrease a lower limit of the first range of data values, move a second end of the range feature to increase or decrease an upper limit of the first range of data values, or move the range feature to shift or translate a position of the first range of data values to adjust the lower range limit and the upper range limit while in highlight mode.

In one example of the computer implemented method, further comprising automatically adjust the range feature, the single color step in the range region, and the first range of data values displayed in the field view based on the user input for the range feature.

In one example of the computer implemented method, wherein the user input moves a first end of the range feature to increase or decrease a lower limit of the first range of data values to form a second range of data values.

In one example of the computer implemented method, wherein the user input moves a second end of the range feature to increase or decrease an upper limit of the first range of data values to form a third range of data values.

In one example of the computer implemented method, wherein the user input moves the range feature to shift or translate a position of the first range of data values to adjust the lower range limit and the upper range limit to form a fourth range of data values.

### BRIEF DESCRIPTION OF THE DRAWINGS

The present disclosure is illustrated by way of example, and not by way of limitation, in the figures of the accompanying drawings and in which:

FIG. 1 shows an example of a system for performing agricultural operations (e.g., planting operations) of agricultural fields including operations of an implement having row units in accordance with one embodiment.

FIG. 2 illustrates a flow diagram of one embodiment for a method 200 of adjusting a range feature of an editor to automatically adjust a range of data values, a range region, and corresponding field views of agricultural fields.

FIG. 3 illustrates a monitor or display device having a user interface 301 with adjustable range region, editor, and field view regions in accordance with one embodiment.

FIGS. 4-8 illustrate different user interfaces 401, 501, 601, 701, and 801 in accordance with some embodiments.

FIG. 9 shows an example of a block diagram of a self-propelled implement 140 (e.g., sprayer, spreader, irrigation implement, etc.) in accordance with one embodiment.

FIG. 10 shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

FIG. 11 is a side elevation view of a row unit 10 of an agricultural planter with a seed firmer 100 mounted to the row unit 10.

### DETAILED DESCRIPTION

Described herein are systems and methods for adjusting a range feature of an editor tool and automatically adjusting a range of values in a range region and automatically adjusting corresponding views of visualized data (such as from agricultural fields). While illustrated with visualized data obtained from agricultural fields, the described operations can be used with any visualized data. In one embodiment, a data processing system (e.g., planter monitor of a cab, display system, tractor, machine, apparatus, computing device, user device, drone, self-guided device, self-propelled device, etc.) can generate and cause a display device to display a localized view map layer that is geographically associated with a selected region of a field map.

In one embodiment, a computer implemented method includes displaying a user interface (UI) on the display device with the UI displaying a range region having a first number of color steps to illustrate a first range of data values for a parameter, an editor tool, and a field view region to display the first range of data values for the parameter in an agricultural field. The method includes receiving, with a range feature of the editor tool, a user input to adjust a position, a first end for a lower limit, or a second end for an upper limit of the range feature to adjust the first range of data values of the parameter and automatically generating an adjusted range region having an adjusted second range of data values of the parameter and also automatically generating a corresponding adjusted field region having the adjusted second range of data values based on the user input.

The user does not need to manually adjust the field view because this adjustment dynamically occurs automatically upon adjusting the range feature. The enhanced graphical user interface allows the user (e.g., grower, farmer, or operator) to quickly understand and selectively highlight potential zones in the field that need further analysis. Most map legends need to be adjusted to help optimize the user's understanding of the data. The range region having a number of color steps to illustrate a range of data values for a parameter, an editor tool, and a field view region provide selectable and adjustable graphical features to accelerate this process such that the user can easily see and understand optimal customized settings for the map legend in order to agronomically understand what occurred in their field during an agricultural operation. The user can adjust one or more parameters for agricultural operations dynamically or at a later time if needed based on the use of the graphical features, which enable improved presentation of large quantities of agricultural data that are collected during an agricultural operation.

In the following description, numerous details are set forth. It will be apparent, however, to one skilled in the art, that embodiments of the present disclosure may be practiced without these specific details. In some instances, well-known structures and devices are shown in block diagram form, rather than in detail, in order to avoid obscuring the present disclosure.

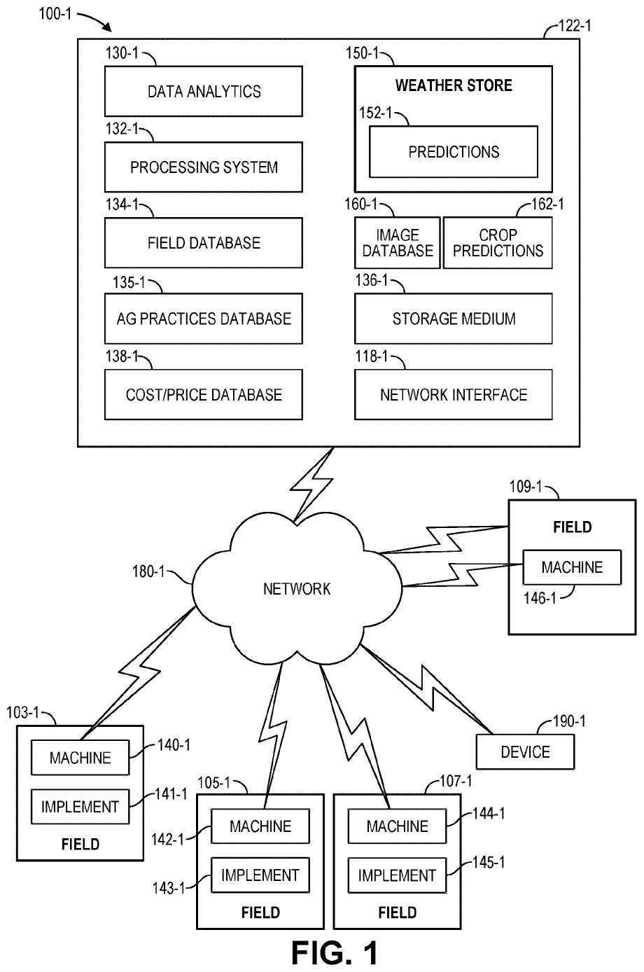

FIG. 1 shows an example of a system for performing agricultural operations (e.g., planting operations, tillage operations, irrigation operations, fluid operations, etc.) of agricultural fields including operations of an implement having row units in accordance with one embodiment. For example, and in one embodiment, the system 100-1 may be implemented as a cloud based system with servers, data processing devices, computers, etc. Aspects, features, and functionality of the system 100-1 can be implemented in servers, planters, planter monitors, combines, implements, laptops, tablets, computer terminals, client devices, user devices (e.g., device 190-1), handheld computers, personal digital assistants, cellular telephones, cameras, smart phones, mobile phones, computing devices, or a combination of any of these or other data processing devices.

In other embodiments, the system includes a network computer or an embedded processing device within another device (e.g., display device) or within a machine (e.g., planter, combine), or other types of data processing systems having fewer components or perhaps more components than that shown in FIG. 1. The system 100-1 (e.g., cloud based system) and agricultural operations can control and monitor planting operations for planting within a planting furrow or trench using an implement or machine. The system 100-1 includes machines 140-1, 142-1, 144-1, 146-1 and implements 141-1, 143-1, 145-1 coupled to a respective machine. The implements (or machines) can include row units for planting operations of rows of crops within associated fields (e.g., fields 103-1, 105-1, 107-1, 109-1). The system 100-1 includes an agricultural analysis system 122-1 that includes a weather store 150-1 with current and historical weather data, weather predictions module 152-1 with weather predictions for different regions, and at least one processing system 132-1 for executing instructions for controlling and monitoring different operations (e.g., planting, fertilizing). The storage medium 136-1 may store instructions, software, software programs, etc. for execution by the processing system and for performing operations of the agricultural analysis system 122-1. In one example, storage medium 136-1 may contain a planting prescription (e.g., planting prescription that relates georeferenced positions in the field to planting parameters (e.g., soil type, downforce, speed, seed orientation, etc.). The implement 141-1 (or any of the implements) may include an implement 200-1 whose sensors and/or controllers may be specifically the elements that are in communication with the network 180-1 for sending control signals or receiving as-applied data.

An image database 160-1 stores captured images of plants or crops at different growth stages and seed at different positions and orientation in a seed passageway during planting. A data analytics module 130-1 may perform analytics on agricultural data (e.g., images, weather, field, yield, etc.) to generate crop predictions 162-1 relating to agricultural operations.

A field information database 134-1 stores agricultural data (e.g., crop growth stage, soil types, soil characteristics, moisture holding capacity, etc.) for the fields that are being monitored by the system 100-1. An agricultural practices information database 135-1 stores farm practices information (e.g., as-applied planting information (e.g., seed orientation), as-applied spraying information, as-applied fertilization information, planting population, applied nutrients (e.g., nitrogen), yield levels, proprietary indices (e.g., ratio of seed population to a soil parameter), etc.) for the fields that are being monitored by the system 100-1. An implement can obtain seed orientation data and provide this data to the system 100-1. A cost/price database 138-1 stores input cost information (e.g., cost of seed, cost of nutrients (e.g., nitrogen)) and commodity price information (e.g., revenue from crop).

The system 100-1 shown in FIG. 1 may include a network interface 118-1 for communicating with other systems or devices such as drone devices, user devices, and machines (e.g., planters, combines) via a network 180-1 (e.g., Internet, wide area network, WiMax, satellite, cellular, IP network, etc.). The network interface include one or more types of transceivers for communicating via the network 180-1.

The processing system 132-1 may include one or more microprocessors, processors, a system on a chip (integrated circuit), or one or more microcontrollers. The processing system includes processing logic for executing software instructions of one or more programs. The system 100-1 includes the storage medium 136-1 for storing data and programs for execution by the processing system. The storage medium 136-1 can store, for example, software components such as a software application for controlling and monitoring planting operations or any other software application. The storage medium 136-1 can be any known form of a machine readable non-transitory storage medium, such as semiconductor memory (e.g., flash; SRAM; DRAM; etc.) or non-volatile memory, such as hard disks or solid-state drive.

While the storage medium (e.g., machine-accessible non-transitory medium) is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present disclosure. The term “machine-accessible non-transitory medium” shall accordingly be taken to include, but not be limited to, solid-state memories, optical and magnetic media, and carrier wave signals.

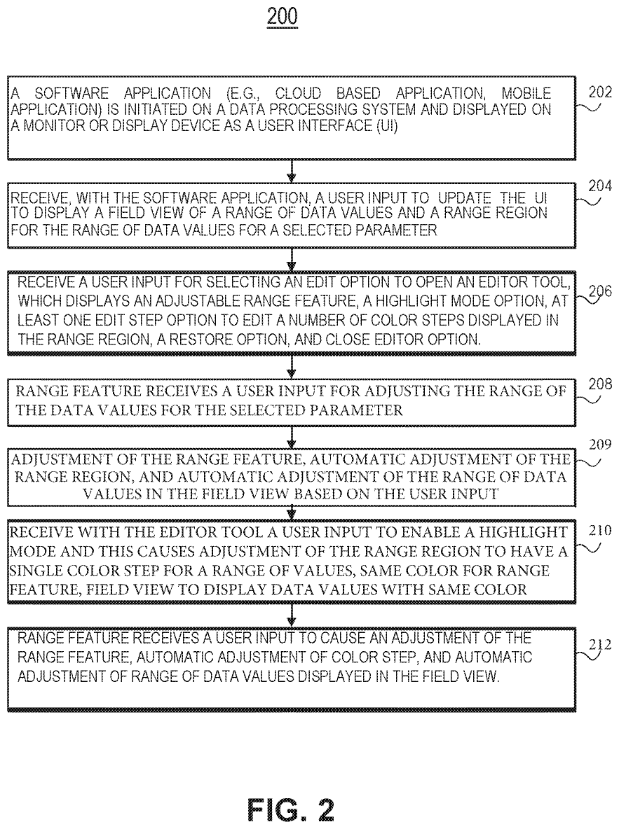

FIG. 2 illustrates a flow diagram of one embodiment for a method 200 of adjusting a range feature of an editor to automatically adjust a range of data values, a range region, and corresponding field views of agricultural fields. The method 200 is performed by processing logic that may comprise hardware (circuitry, dedicated logic, graphics processing unit (GPU), etc.), software (such as is run on a general purpose computer system or a dedicated machine or a device), or a combination of both. In one embodiment, the method 200 is performed by processing logic of at least one data processing system (e.g., system 100-1, server, machine, apparatus, monitor, display device, computing device, user device, self-guided device, self-propelled device, etc.). The data processing system executes instructions of a software application or program with processing logic. The software application or program can be initiated by the data processing system. In one example, a monitor or display device receives user input and provides a customized display for operations of the method 200.

At operation 202, a software application (e.g., cloud based application, mobile application) is initiated on a data processing system (e.g., system 100-1, processing system 132-1, 1200, 162, machine, apparatus, user device, self-guided device, self-propelled device, etc.) and displayed on a monitor or display device as a user interface. The data processing system may be integrated with or coupled to a machine that performs an application pass (e.g., planting, tillage, fertilization, irrigation, etc.). Alternatively, the data processing system may be integrated with an apparatus (e.g., drone, image capture device) associated with the machine that captures images during the application pass. The user interface can include different selectable system parameters (e.g., plant summary for planting data, closing for trench closing parameters, down force, insecticide for area covered and product dispensed during an application, weed & feed for area covered and product dispensed during an application, nitrogen for area covered and product dispensed during an application, starter, fungicide for area covered and product dispensed during an application, seeding, population, spacing, singulation, organic matter, temperature, vehicle or implement speed, or any measured property) of a field region, a mapping region to select a map option (e.g., map with details, full width map, region explorer, split map comparison, and diagnostic timeline), a field view region, a range region, and an editor tool. A down force parameter can indicate a field average or per row unit details for average force on opening discs in soil, ground contact, force margin for weight on gauge wheels any time during planting, and force minimum during planting.

At operation 204, the software application receives user input to select a parameter from a system parameter region, and update the user interface that is displayed with the monitor or display device. The user interface is generated based on the user input and may include a field view of data values for the selected parameter and a range region for a range of data values of the selected parameter. The range region can include a plurality of color steps with each color representing a different range of data values for the selected parameter (e.g., for a first parameter: −50 to 0 lbs of down force for a first color of the range region, 0 to 50 lbs of down force for a second color, 50 to 100 lbs of down force for a third color, for a second parameter: 500 to 750 units of applied fluid for a first color of the range region, 750 to 1000 units of applied fluid for a second color, 1000 to 1250 units of applied fluid for a third color, etc.). At operation 206, the software application receives a user input (e.g., mouse input, touch user input, any type of user input) for selecting an edit option to cause a popup window of an editor tool (or editor) to be displayed adjacent to the range region and displayed over a portion of the field view for the selected parameter.

In one example, the editor tool displays an adjustable range feature (e.g., range bar) having a first end and a second end, a highlight mode option, at least one edit step option to edit (e.g., increase, decrease) a number of color steps displayed in the range region, a restore option, and a close editor option to close the editor tool.

At operation 208, the range feature (e.g., range bar) of the editor tool receives a user input (e.g., mouse input, touch user input, any type of user input, zoom in to a smaller range of data values for the selected parameter, zoom out to a larger range of data values for the selected parameter, expand that can refer to positive expansion or negative expansion (contraction), pan) for adjusting the range (e.g., a range bar) of the data values for the selected parameter in the range region and this single user input dynamically causes at operation 209 adjustment of the range feature, automatic adjustment of range in the range region, and automatic adjustment of the range of data values in the field view. A first expand operation can be a pinch motion with 2 user input points contacting the range feature and moving towards each other to expand in (or contract) (e.g., 1 finger and 1 thumb or 2 fingers). A second expand operation (e.g., expand with 2 user input points contacting the range feature moving away from each other to expand out) causes the range feature to expand out. A panning input (e.g., panning with 1 user input point contacting the range feature and moving upwards (or downwards), e.g. 1 finger or 1 thumb) to move the range feature along a slide.

The user input can move a first end of the range feature (e.g., range bar) to increase or decrease a lower range limit of data values, move a second end of the range feature (e.g., range bar) to increase or decrease an upper range limit of data values, move the entire range feature (e.g., range bar) to shift or translate a position of the range of data values to adjust the lower range limit and the upper range limit, or adjust a number of color steps for the range region. In one example, the range region and adjacent editor occupy a smaller region of the user interface and the field view is a larger region of the user interface.

At operation 210, the editor tool receives a user input to enable a highlight mode and this dynamically causes automatic adjustment of the range region to have a single color step for a range of values, an automatic adjustment of the range feature (e.g., range bar) to have the same color, and automatic adjustment of the field view to display data values with the same color for a range of data values.

At operation 212, the range feature (e.g., range bar) receives a user input while in highlight mode and this dynamically causes adjustment of the range feature (e.g., range bar), automatic adjustment of the color step, and automatic adjustment of the range of data values displayed in the field view. The user input can move a first end of the range feature (e.g., range bar) to increase or decrease a lower range of data values, move a second end of the range feature (e.g., range bar) to increase or decrease an upper range of data values, or move the entire range feature (e.g., range bar) to shift or translate a position of the range of data values to adjust the lower range limit and the upper range limit.

Some of the above operations can be repeated if additional user input for modifying the range feature (e.g., range bar) of the editor are received by the software application.

In some embodiments, the operations of the method(s) disclosed herein can be altered, modified, combined, or deleted. The methods in embodiments of the present disclosure may be performed with a device, an apparatus, or data processing system as described herein. The device, apparatus, or data processing system may be a conventional, general-purpose computer system or special purpose computers, which are designed or programmed to perform only one function, may also be used. In one example, all of the above operations of method 200 are performed locally on a device. In another example, most of the above operations of method 200 are performed locally on a device while an operation(s) that adjusts a range region or edits color steps of the range region is performed remotely on a server or with a cloud entity.

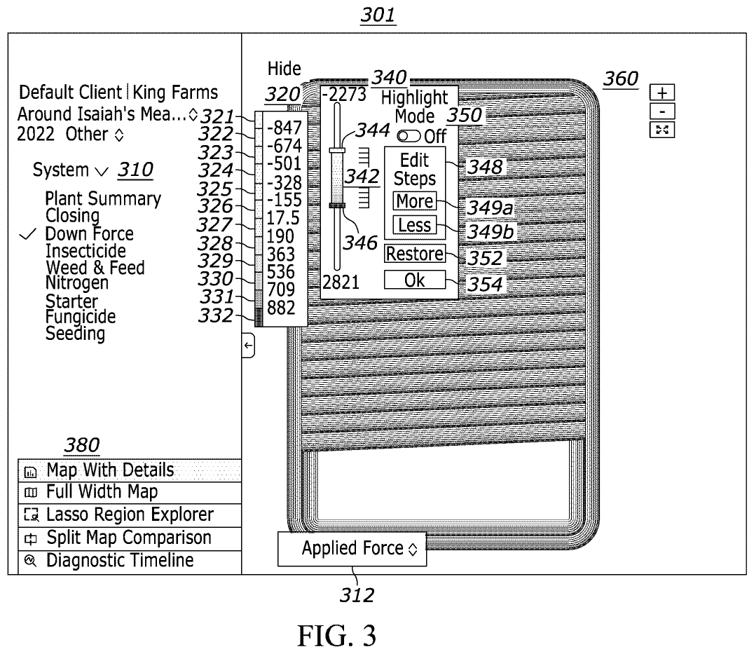

FIG. 3 illustrates a monitor or display device having a user interface 301 with adjustable range region, editor, and field view regions in accordance with one embodiment. An initiated software application (e.g., field application) of a data processing system generates the user interface 301 that is displayed by the monitor or display device.

The software application can provide different display regions that are selectable by a user. In one example, the display regions include a system parameter region 310 having a plurality of parameters, a range region 320 having adjustable color steps 321-332, an editor tool 340, a field view region 360 for the selected parameter, and a mapping option 380 (e.g., map with full details, full width map, region explorer, split map comparison, and diagnostic timeline). The range region 320 can include a plurality of color steps with each color representing a different range of data values for the selected parameter. A popup window of an editor tool 340 is displayed adjacent to the range region 320 and displayed over a portion of the field view region 360 for the selected parameter (e.g., down force, plant summary, closing, insecticide, weed & feed, nitrogen, starter, fungicide, seeding).

In one example, the editor tool displays an adjustable range feature (e.g., range bar 342) 342 having a first end 344 and a second end 346, a highlight mode option 350 that can be switched on/off, at least one edit step option 348 to edit (e.g., increase 349a, decrease 349b) a number of color steps (e.g., 321-332) displayed in the range region 320, a restore option 352 to restore the range feature (e.g., range bar), color steps, and field view to a previous setting from a previous user input, and a close editor option 354 to close the editor.

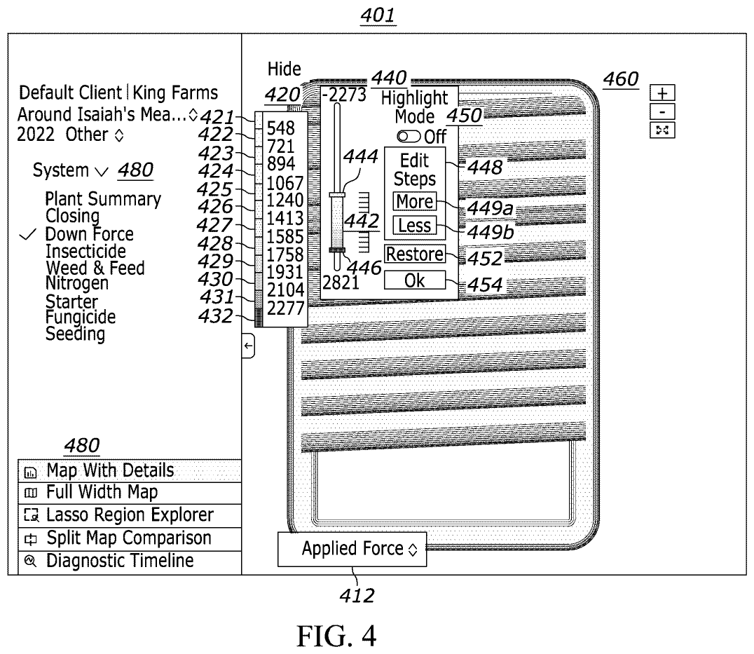

The range feature (e.g., range bar 342) 342 of the editor can receive a user input (e.g., mouse input, touch user input, any type of user input, zoom in to a smaller range of data values for the selected parameter, zoom out to a larger range of data values for the selected parameter, expand that can refer to positive expansion or negative expansion (contraction), pan) for adjusting the range (e.g., a range feature (e.g., range bar)) in the editor and this single user input dynamically causes automatic adjustment of the colors and position of the range feature (e.g., range bar), the color steps in the range region, and the data values and colors in the field view region (e.g., zoom in to a smaller range of data values for the selected parameter, zoom out to a larger range of data values for the selected parameter). The user input can move a first end 344 of the range feature (e.g., range bar 342) 342 to increase or decrease a lower range limit of data values, move a second end 346 of the range feature (e.g., range bar) 342 to increase or decrease an upper range limit of data values, or move the entire range feature (e.g., range bar) by selecting an interior region of the range feature (e.g., range bar) to shift or translate a position of the range of data values (e.g., −847 to 882 in range region of FIGS. 3, 548 to 2277 in range region of FIG. 4) to adjust the lower range limit and the upper range limit for the color steps of the range region. In one example, the range region and adjacent editor occupy a smaller region of the user interface and the field view is a larger region of the user interface.

FIGS. 4-8 display user interfaces 401, 501, 601, 701, and 801 with similar display regions as user interface 301 of FIG. 3 including system parameter region (e.g., parameter region 410, 510, 610, 710, 810) having a plurality of parameters, a range region (e.g., range region 420, 520, 620, 720, 820) having adjustable color steps (e.g., color steps 421-432, 521-532, 621-623, 721, 821), an editor (e.g., editor 440, 540, 640, 740, 840), a field view region (e.g., field view region 460, 560, 660, 760, 860) for the selected parameter (e.g., parameter 412, 512, 612, 712, 812), and a mapping option (e.g., mapping option 480, 580, 680, 780, 880 having map with full details, full width map, region explorer, split map comparison, and diagnostic timeline). The range region can include a plurality of color steps with each color representing a different range of data values for the selected parameter. A popup window of an editor tool (e.g., editor tool 440, 540, 640, 740, 840) is displayed adjacent to the range region and displayed over a portion of the field view region 460 for the selected parameter (e.g., down force, plant summary, closing, insecticide, weed & feed, nitrogen, starter, fungicide, seeding).

In one example, the editor tool displays an adjustable range feature (e.g., range bar) (e.g., range feature (e.g., range bar) 442, 542, 642, 742, 842) having a first end (e.g., first end 444, 544, 644, 744, 844) and a second end (e.g., second end 446, 546, 666, 746, 846), a highlight mode option (e.g., option 450, 550, 650, 750, 850) that can be switched on/off, at least one edit step option (e.g., edit step option 448, 548, 648) to edit (e.g., increase 449a, 549a, 649a, decrease 449b, 549b, 649b) a number of color steps displayed in the range region, a restore option (e.g., option 452, 552, 652) to restore the range feature (e.g., range bar), color steps, and field view to a previous setting from a previous user input, and a close editor option (e.g., option 454, 554, 654, 754, 854) to close the editor.

FIG. 4 has the same number of color steps compared to FIG. 3. A user input has selected the range feature (e.g., range bar 342) 342 and shifted the entire range feature (e.g., range bar) downwards into a lower position as illustrated in range feature (e.g., range bar) 442 of FIG. 4. Due to this shift in the range feature (e.g., range bar), the range for the color steps has automatically changed from −847 to 882 lbs in FIGS. 3 to 548 to 2277 lbs in FIG. 4 and the data values shown in the field view region 460 has also automatically changed to correspond to the color steps in range region 420.

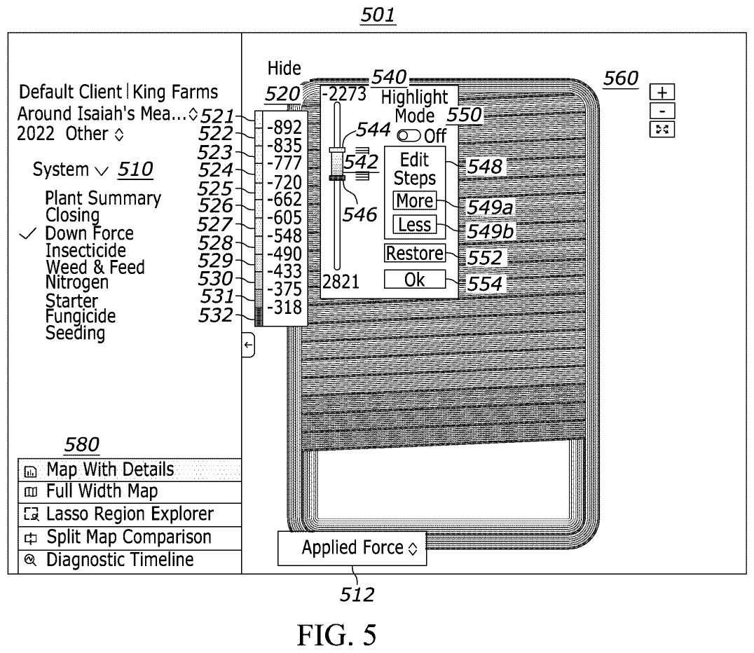

For FIG. 5, the range of data values has been reduced to −892 to −318 lbs as shown in range region 520 based on user input moving a position of the range feature (e.g., range bar) and also moving a first end 544 and second end 546 towards each other to automatically reduce the range in the range region 520 and the range of data values displayed in the field view 560.

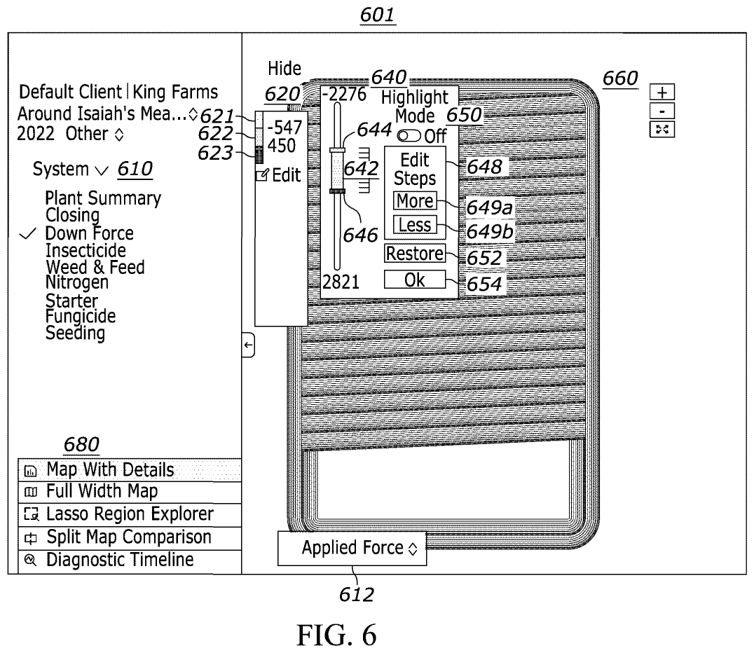

For FIG. 6, user input has selected less steps 649b to reduce color steps for color steps 621-623. The range of data values has been adjusted to −547 to 450 lbs as shown in range region 620 based on user input moving a position of the range feature (e.g., range bar) and also moving a first end 644 and second end 646 away from each other to automatically increase the range in the range region 620 and the range of data values displayed in the field view 660.

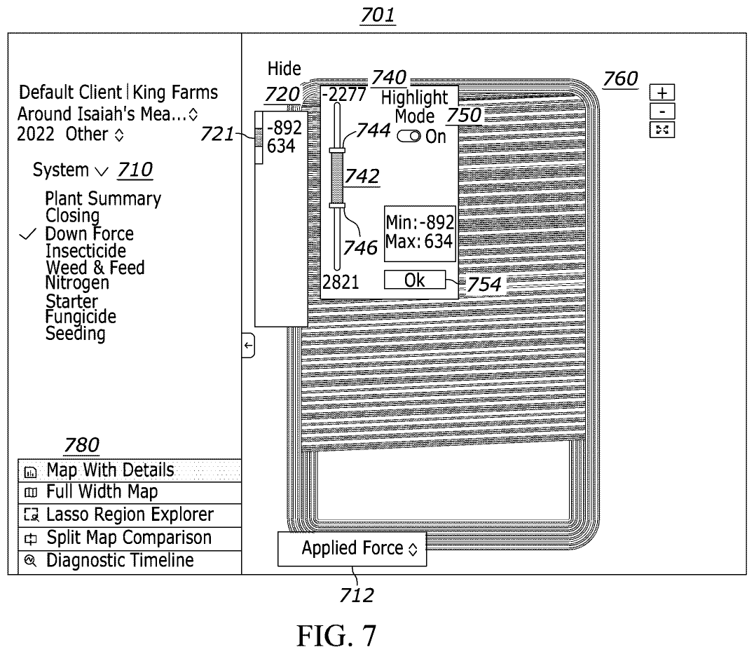

For FIG. 7, user input has enabled highlight mode 750 and this causes a single color step 721 to be shown in range feature (e.g., range bar 742) 742 and color step 721. The range feature (e.g., range bar 742) has been adjusted to cause a range −892 to 634 lbs to be displayed in the range region 720 and also in the field view region 760. Minimum and maximum values for the current color step are shown in the editor 740. A grower can highlight a specific range of values for a parameter and track its location throughout the field with the field view region 760.

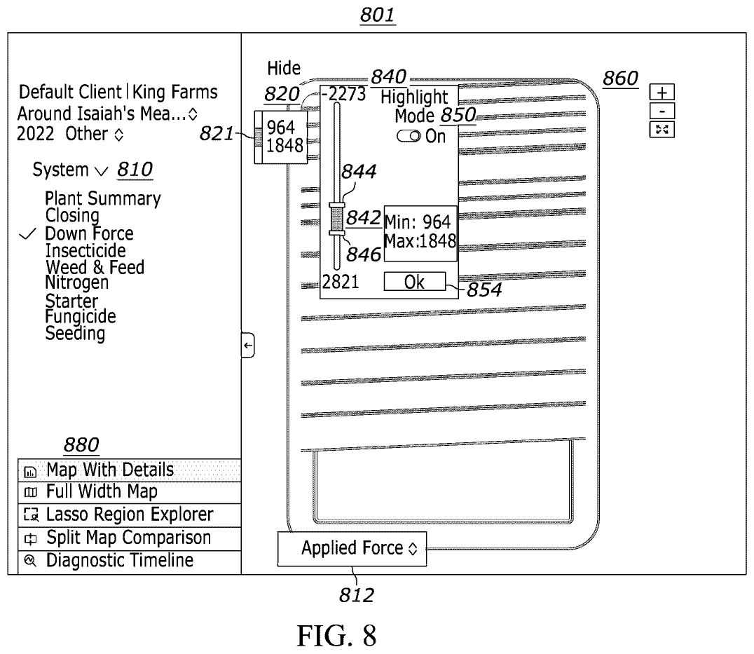

For FIG. 8, user input has enabled highlight mode 850 and this causes a single color step to be shown in range feature (e.g., range bar 842) 842 and color step 821. The range feature (e.g., range bar) has been adjusted to cause a range 964 to 1848 lbs to be displayed in the range region 820 and also in the field view region 860. Minimum and maximum values for the current color step are shown in the editor 840. A grower can highlight a specific range of values for a parameter and track its location throughout the field with the field view region 860.

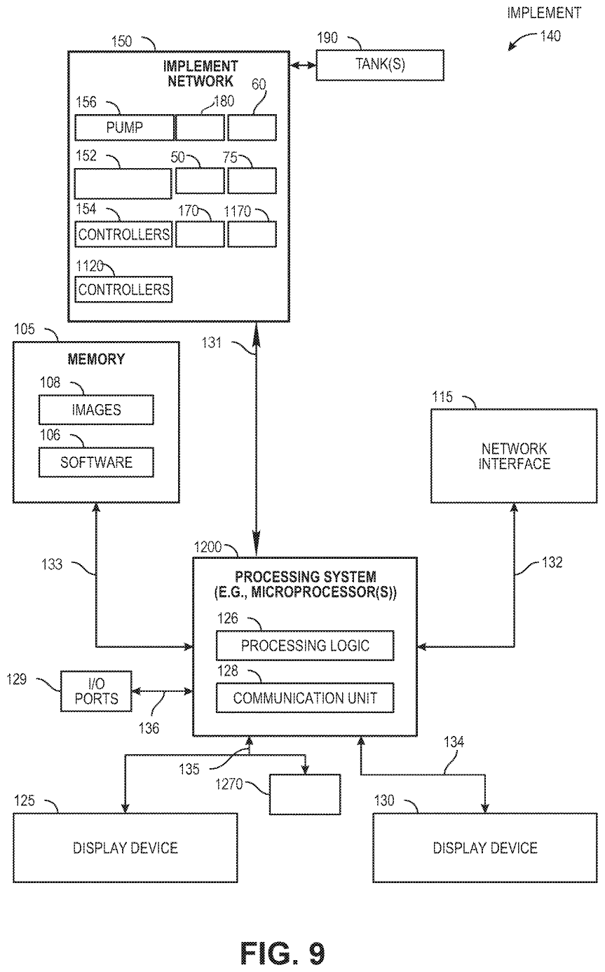

FIG. 9 shows an example of a block diagram of a self-propelled implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 9. The I/O ports 129 (e.g., diagnostic/on board diagnostic (OBD) port) enable communication with another data processing system or device (e.g., display devices, sensors, etc.).

In one example, the self-propelled implement 140 performs operations for planting applications of a field. Data associated with the planting applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as application software for analysis of planting applications for performing operations of the present disclosure, or any other software application or module, reflectance signals from sensor arrays, images (e.g., images of seed in a seed passageway, captured images of crops, images of a spray pattern for rows of crops, images for camera calibrations), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., planting application data with seed orientation, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication module 180 for receiving communications from controllers and sensors and transmitting these communications. In one example, the implement network 150 includes nozzles 50, lights 60, and vision system 75 having cameras and processors for various embodiments of this present disclosure.

Sensors 152 (e.g., speed sensors, seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation, light-emitting diodes (LEDs), laser diodes) having light arrays for detecting passage of seed, downforce sensors, actuator valves, OEM sensors, flow sensors, etc.), controllers 154 (e.g., drive system, GPS receiver), and the processing system 120 control and monitoring operations of the implement. The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

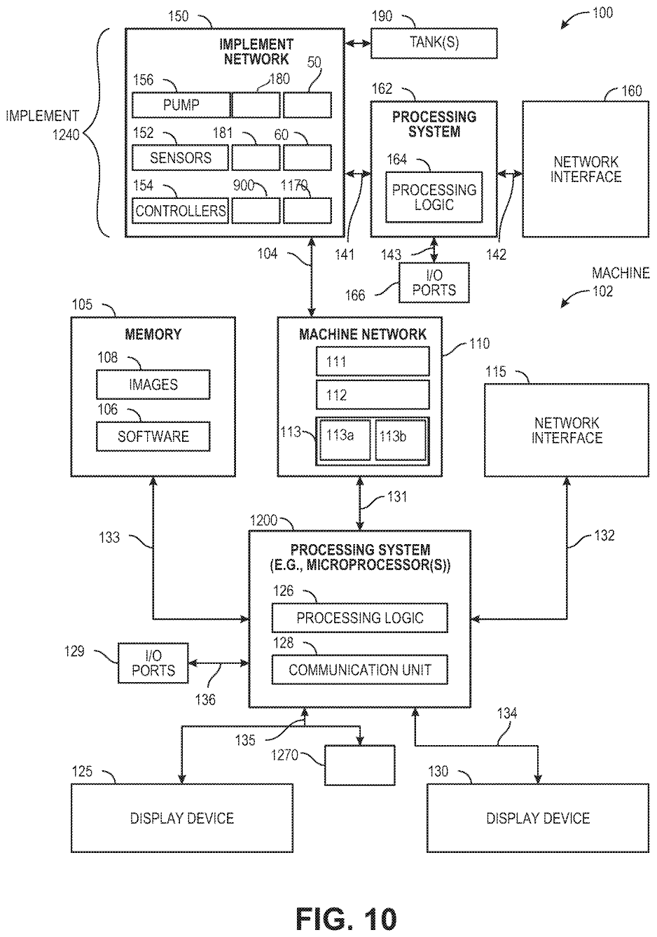

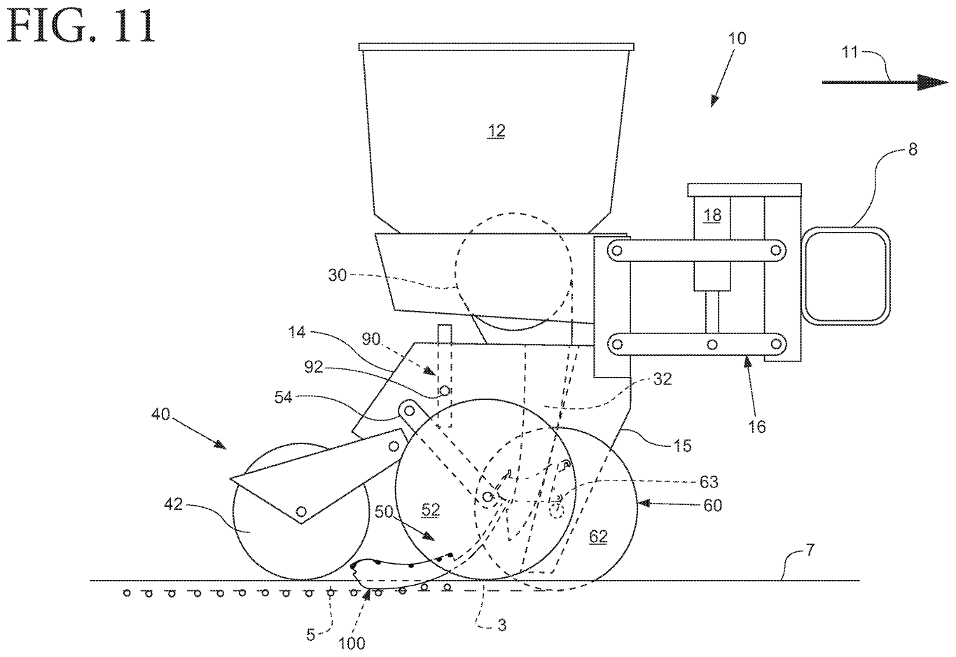

FIG. 10 shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (POE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 11B. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., planting data with seed orientation data, GPS data, liquid application data, flow rates, weed parameters a crop identification, a camera height from a camera to a ground level, a crop stress indicator, a drought stress indicator, and insect indicator for different target regions, etc.). The system 1200 includes memory 105 for storing data and programs for execution (software 106) by the processing system. The memory 105 can store, for example, software components such as planting application software for analysis of planting applications for performing operations of the present disclosure, or any other software application or module, images (e.g., images of seed in a seed passageway, images for camera calibrations, captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 120 communicates bi-directionally with memory 105, machine network 110, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., seed orientation data, weed parameters, a crop identification, planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, weed parameters, controls a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e.g, Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes nozzles 50, lights 60, vision system 1170 having cameras and processors, and autosteer controller 900 for various embodiments of this present disclosure. The autosteer controller 900 may also be part of the machine network 110 instead of being located on the implement network 150 or in addition to being located on the implement network 150.

Sensors 152 (e.g., speed sensors, seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, liquid application sensors for a sprayer, or vacuum, lift, lower sensors for an implement. For example, the controllers may include processors in communication with a plurality of seed sensors. The processors are configured to process data (e.g., liquid application data, seed sensor data) and transmit processed data to the processing system 162 or 120. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 10.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

In one example, the implement 140, 1240 is an autosteered implement comprising a self-propelled implement with an autosteer controller 1120 for controlling traveling of the self-propelled implement. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled implement.

In another example, the machine 102 is an autosteered machine comprising a self-propelled machine with an autosteer controller 1120 for controlling traveling of the self-propelled machine and any implement that is coupled to the machine. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled machine.

In another example, a boom actuation system 170 moves a boom arm 22 of the implement between a storage position and a deployed position, and the arm is actuated with the boom actuation system.

In one embodiment, a machine-accessible non-transitory medium (e.g., memory 105) contains executable computer program instructions which when executed by a data processing system cause the system to perform operations or methods of the present disclosure.

It will be appreciated that additional components, not shown, may also be part of the system in certain embodiments, and in certain embodiments fewer components than shown in FIG. 9 and FIG. 10 may also be used in a data processing system. It will be appreciated that one or more buses, not shown, may be used to interconnect the various components as is well known in the art.

FIG. 11 is a side elevation view of a row unit 10 of an agricultural planter with a seed firmer 100 mounted to the row unit 10. It should be understood that the planter comprises a plurality of row units 10 mounted along the toolbar 8 in spaced relation. The row units 10 are mounted to the toolbar 8 by a parallel arm linkage 16 permitting the individual row units 10 to independently translate vertically with respect to the toolbar 8. The row unit 10 is shown as incorporating an actuator 18 mounted to the toolbar 8 and the parallel arm linkage 16 to apply supplemental downpressure (down force) to the row unit 10.

The row unit 10 includes a frame 14 having a downwardly extending shank 15. The frame 14 supports an opening disc assembly 60, a gauge wheel assembly 50 and a closing assembly 40. The opening assembly 60 includes two opening discs 62 rotatable about a shaft 63 supported by the shank 15. The opening discs 62 are disposed to cut a v-shaped trench 3 in the soil surface 7 as the row unit is drawn through the field in the direction of arrow 11. The gauge wheel assembly 50 includes two gauge wheels 52 pivotally mounted to the frame 14 by gauge wheel arms 54. A depth adjustment assembly 90 adjustably positions the gauge wheels 52 with respect to the opening discs 62 by contacting the gauge wheel arms 54 to limit the upward travel of the gauge wheel arms 54, thus limiting the depth of the trench 3 opened by the opening discs 62. The closing assembly 40 may include closing wheels 42 disposed to move soil back into the trench 3 to cover the seeds previously deposited as discussed below.

Continuing to refer to FIG. 11, seeds 5 are communicated from a hopper 12 to a seed

meter 30 which dispenses seeds into the seed tube 32 extending downwardly and rearwardly toward the seed trench 3 between the opening discs 62 and the gauge wheels 52. In operation, as the planter is drawn through the field in the direction of arrow 11, the seeds 5 dispensed by the meter 30 are directed downwardly and rearwardly by the seed tube 32 where they are deposited in the seed trench 3 formed by the opening discs 62. A seed firmer 100 presses the deposited seeds 5 into the soil at the bottom of the seed trench 3 before the seeds are covered with soil by the closing assembly 40 having a closing force.

Any of the following examples can be combined into a single embodiment or these examples can be separate embodiments. The following are non-limiting examples.

Example 1 is a computer implemented method for adjusting a range of data values on a display device comprising displaying a user interface (UI) on the display device with the UI displaying a range region having a first number of color steps to illustrate a first range of data values for a parameter, an editor tool, and a field view region to display the first range of data values for the parameter in an agricultural field. The method includes receiving, with a range feature of the editor tool, a user input to adjust a position, a first end for a lower limit, or a second end for an upper limit of the range feature to adjust the first range of data values of the parameter, and automatically generating an adjusted range region having an adjusted second range of data values of the parameter and also automatically generating a corresponding adjusted field region having the adjusted second range of data values based on the user input.

Example 2—The computer implemented method of Example 1, further comprising displaying, with the display device, the adjusted range region having an adjusted second range of data values of the parameter and the corresponding adjusted field region having the adjusted second range of data values based on the user input.

Example 3—The computer implemented method of any of Examples 1-2, wherein the user input to adjust a position of the range feature to shift the first range of data values higher or lower.

Example 4—The computer implemented method of any of Examples 1-3, wherein the user input to adjust a first end of the range feature to adjust a lower limit of the first range of data values to form a second range of data values.

Example 5—The computer implemented method of any of Examples 1-4, wherein the user input to adjust a second end of the range feature to adjust an upper limit of the first range of data values of the parameter to form a third range of data values.

Example 6—The computer implemented method of any of Examples 1-5, further comprising receiving, with the editor tool, a user input to edit the first number of color steps with each step having a range of data values displayed in the range region.

Example 7—The computer implemented method of any of Examples 1-6, further comprising automatically changing the range region to have a second number of steps with each step having an adjusted range of data values based on the user input for the editor tool.

Example 8—The computer implemented method of any of Examples 1-7, wherein the parameter comprises plant summary, closing, down force, insecticide, weed & feed, nitrogen, starter, fungicide, seeding, or population.

Example 9 is a system comprising a display device for displaying a user interface having a range region with a first number of color steps to illustrate a first range of data values for a parameter, an editor tool, and a field view region to display the first range of data values for the parameter in an agricultural field and at least one processor coupled to the display device. The at least one processor is configured to execution instructions to generate data for the user interface (UI) of the display device, to receive from a range feature of the editor tool a user input to adjust a position, a first end for a lower limit, or a second end for an upper limit of the range feature to adjust the first range of data values of the parameter, and automatically generate an adjusted range region having an adjusted second range of data values of the parameter and also automatically generate a corresponding adjusted field region having the adjusted second range of data values based on the user input.

Example 10—The system of Example 9, wherein the display device is configured to display the adjusted range region having an adjusted second range of data values of the parameter and the corresponding adjusted field region having the adjusted second range of data values based on the user input.

Example 11—The system of any of Examples 9-10, wherein the user input to adjust a position of the range feature to shift the first range of data values higher or lower.

Example 12—The system of any of Examples 9-11, wherein the user input to adjust a first end of the range feature to adjust a lower limit of the first range of data values.

Example 13—The system of any of Examples 9-12, wherein the user input to adjust a second end of the range feature to adjust an upper limit of the first range of data values of the parameter.

Example 14—The system of any of Examples 9-13, further comprising receiving, with the editor tool, a user input to edit the first number of color steps with each step having a range of data values displayed in the range region.

Example 15—The system of any of Examples 9-14, further comprising automatically changing the range region to have a second number of steps with each step having an adjusted range of data values based on the user input for the editor tool.

Example 16—The system of any of Examples 9-15, wherein the parameter comprises plant summary, closing, down force, insecticide, weed & feed, nitrogen, starter, fungicide, seeding, or population.

Example 17—a computer implemented method for adjusting range of a range region and corresponding field views of a field region of data displays comprising displaying a user interface (UI) on a display device with the UI displaying a range region having a number of color steps to illustrate a first range of data values for a parameter, an editor tool, and a field view region to display the first range of data values for the parameter in an agricultural field, receiving, with a range feature of the editor tool, a user input to enable a highlight mode, and automatically adjusting the range region to have a single color step for the first range of data values, adjusting the range feature to have the same color as the single color step, and adjusting the field view to display the first range of data values with the same color as the single color step based on the user input for the highlight mode.

Example 18—The computer implemented method of Example 17, further comprising receiving, with the range feature, a user input to move a first end of the range feature to increase or decrease a lower limit of the first range of data values, move a second end of the range feature to increase or decrease an upper limit of the first range of data values, or move the range feature to shift or translate a position of the first range of data values to adjust the lower range limit and the upper range limit while in highlight mode.

Example 19—The computer implemented method of Example 18, further comprising automatically adjust the range feature, the single color step in the range region, and the first range of data values displayed in the field view based on the user input for the range feature.

Example 20—The computer implemented method of any of Examples 18-19, wherein the user input moves a first end of the range feature to increase or decrease a lower limit of the first range of data values to form a second range of data values.

Example 21—The computer implemented method of any of Examples 18-20, wherein the user input moves a second end of the range feature to increase or decrease an upper limit of the first range of data values to form a third range of data values.

Example 22—The computer implemented method of any of Example 18-21, wherein the user input moves the range feature to shift or translate a position of the first range of data values to adjust the lower range limit and the upper range limit to form a fourth range of data values.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A computer implemented method for adjusting a range of data values on a display device comprising:
displaying a user interface (UI) on the display device with the UI displaying a range region having a first number of color steps to illustrate a first range of data values for a parameter, an editor tool, and a field view region to display the first range of data values for the parameter in an agricultural field;
receiving, with a range feature of the editor tool, a user input to adjust a position, a first end for a lower limit, or a second end for an upper limit of the range feature to adjust the first range of data values of the parameter; and
automatically generating an adjusted range region having an adjusted second range of data values of the parameter and also automatically generating a corresponding adjusted field region having the adjusted second range of data values based on the user input.

2. The computer implemented method of claim 1, further comprising:
displaying, with the display device, the adjusted range region having an adjusted second range of data values of the parameter and the corresponding adjusted field region having the adjusted second range of data values based on the user input.

3. The computer implemented method of claim 1, wherein the user input to adjust a position of the range feature to shift the first range of data values higher or lower.

4. The computer implemented method of claim 1, wherein the user input to adjust a first end of the range feature to adjust a lower limit of the first range of data values to form a second range of data values.

5. The computer implemented method of claim 1, wherein the user input to adjust a second end of the range feature to adjust an upper limit of the first range of data values of the parameter to form a third range of data values.

6. The computer implemented method of claim 1, further comprising:
receiving, with the editor tool, a user input to edit the first number of color steps with each step having a range of data values displayed in the range region.

7. The computer implemented method of claim 5, further comprising:
automatically changing the range region to have a second number of steps with each step having an adjusted range of data values based on the user input for the editor tool.

8. The computer implemented method of claim 1, wherein the parameter comprises plant summary, closing, down force, insecticide, weed & feed, nitrogen, starter, fungicide, seeding, or population.

9. A system comprising:
a display device for displaying a user interface having a range region with a first number of color steps to illustrate a first range of data values for a parameter, an editor tool, and a field view region to display the first range of data values for the parameter in an agricultural field; and
at least one processor coupled to the display device, the at least one processor is configured to execution instructions to generate data for the user interface (UI) of the display device, to receive from a range feature of the editor tool a user input to adjust a position, a first end for a lower limit, or a second end for an upper limit of the range feature to adjust the first range of data values of the parameter, and automatically generate an adjusted range region having an adjusted second range of data values of the parameter and also automatically generate a corresponding adjusted field region having the adjusted second range of data values based on the user input.

10. The system of claim 9, wherein the display device is configured to display the adjusted range region having an adjusted second range of data values of the parameter and the corresponding adjusted field region having the adjusted second range of data values based on the user input.

11. The system of claim 9, wherein the user input to adjust a position of the range feature to shift the first range of data values higher or lower.

12. The system of claim 9, wherein the user input to adjust a first end of the range feature to adjust a lower limit of the first range of data values.

13. The system of claim 9, wherein the user input to adjust a second end of the range feature to adjust an upper limit of the first range of data values of the parameter.

14. The system of claim 9, further comprising:
receiving, with the editor tool, a user input to edit the first number of color steps with each step having a range of data values displayed in the range region.

15. The system of claim 13, further comprising:
automatically changing the range region to have a second number of steps with each step having an adjusted range of data values based on the user input for the editor tool.

16. The system of claim 9, wherein the parameter comprises plant summary, closing, down force, insecticide, weed & feed, nitrogen, starter, fungicide, seeding, or population.

17. A computer implemented method for adjusting range of a range region and corresponding field views of a field region of data displays comprising:
displaying a user interface (UI) on a display device with the UI displaying a range region having a number of color steps to illustrate a first range of data values for a parameter, an editor tool, and a field view region to display the first range of data values for the parameter in an agricultural field;
receiving, with a range feature of the editor tool, a user input to enable a highlight mode; and
automatically adjusting the range region to have a single color step for the first range of data values, adjusting the range feature to have same color as the single color step, and adjusting the field view to display the first range of data values with the same color as the single color step based on the user input for the highlight mode.

18. The computer implemented method of claim 17, further comprising:
receiving, with the range feature, a user input to move a first end of the range feature
to increase or decrease a lower limit of the first range of data values, move a second end of the range feature to increase or decrease an upper limit of the first range of data values, or move the range feature to shift or translate a position of the first range of data values to adjust the lower range limit and the upper range limit while in the highlight mode.

19. The computer implemented method of claim 18, further comprising:
automatically adjust the range feature, the single color step in the range region, and the first range of data values displayed in the field view based on the user input for the range feature.

20. The computer implemented method of claim 19, wherein the user input moves a first end of the range feature to increase or decrease a lower limit of the first range of data values to form a second range of data values.

21. The computer implemented method of claim 19, wherein the user input moves a second end of the range feature to increase or decrease an upper limit of the first range of data values to form a third range of data values.

22. The computer implemented method of claim 19, wherein the user input moves the range feature to shift or translate a position of the first range of data values to adjust the lower range limit and the upper range limit to form a fourth range of data values.
